(19) United States
(12) Patent Application Publication
(10) Pub. No.: US 2026/0349129 A1
(43) Pub. Date: Nov. 5, 2026

(54) SUPPRESSING REFLECTIONS WITH VECTOR REFLECTIVITY ACOUSTIC MODELING

(71) Applicant: SCHLUMBERGER TECHNOLOGY CORPORATION, Sugar Land, TX (US)

(72) Inventors: Robin FLETCHER, Crawley (GB); James HOBRO, Cambridge (GB); James RICKETT, Crawley (GB)

(21) Appl. No.: 19/119,779

(22) PCT Filed: Oct. 13, 2022
(86) PCT No.: PCT/US2022/046568

§ 371 Date: Apr. 10, 2025

(51) Int. Cl. G01V 1/28; G01V 1/36

(52) U.S. Cl. CPC G01V 1/282; G01V 1/364; G01V 2210/32; G01V 2210/56; G01V 2210/673; G01V 2210/679

(57) ABSTRACT

Exemplary methods and systems for minimizing noise during seismic modeling are disclosed. The exemplary methods include receiving seismic data associated with a resource site. The exemplary methods may further generate a model based on the seismic data. In one embodiment, the model has a first noise content associated with the seismic modeling. The noise content, in some embodiments, is due to unwanted signal reflections during the seismic modeling. The exemplary methods may further include generating first data and second data using the wavefields associated with the model and combining the first data and the second data to generate output data. The output data, according to one embodiment has an associated noise content than is less than the first noise content.

### BACKGROUND

For seismic imaging applications associated with resource sites that rely on two-way acoustic modeling, it is useful to suppress selected reflections of the transmitted acoustic signal in order to generate noise-free results during seismic modeling. Examples of such selected reflections include artificial reflections from boundaries of an imposed computational domain and reflections from high velocity contrasts defining a boundary (e.g. modeled top of salt) that cause unwanted imaging artefacts in a reverse-time migration (RTM) model.

### SUMMARY

This disclosure is directed to suppressing reflections from a selected boundary by performing tests using acoustic modeling parameterised by velocity and/or vector reflectivity. The velocity may be fixed or variable during the testing. For example, a first test may include executing a simulation that constrains each component or value of the vector reflectivity associated with a first wavefield to generate first data or a first result set at the selected boundary. The second test may include a simulation that constrains a value of the vector reflectivity associated with a second wavefield to generate second data or a second result set at the boundary. The test may further include executing a combining operation using the first data and the second data to generate output data. In one embodiment, the output data includes suppressed noise (e.g., suppressed unwanted reflections) associated with the selected boundary. A benefit of such an approach is that suppression of energy (e.g., noise) reflected from either side of the selected boundary may be achieved using the disclosed method. According to one implementation, the disclosed technology can allow averaging of simulations to suppress or otherwise attenuate unwanted energy that has reflected from the selected boundary a number of times (e.g., an odd number of times). Moreover, the disclosed techniques enable mechanisms that can also combine or otherwise average a plurality of tests or simulations based on selectively encoding reflectivity values associated with the selected boundary with values that facilitate the suppression of noise during the modeling.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 illustrates an exemplary high-level flowchart

FIG. 2 illustrates a cross-sectional view of a resource site for which the process of FIG. 1 may be executed.

FIG. 3 illustrates a high-level networked system illustrating a communicative coupling of devices or systems associated with the resource site of FIG. 2.

FIGS. 4A(a)-(d) illustrate a first exemplary data associated with examples of the disclosed seismic modeling.

FIGS. 4B(a)-(d) illustrate a second exemplary data associated with examples of the disclosed seismic modeling.

FIG. 5 illustrates an exemplary chart indicating a cost ratio for different sized computational domains associated with examples of the disclosed seismic modeling.

FIG. 6A-6E illustrate exemplary test or simulation data associated with suppressing energy that has reflected during execution of examples of the disclosed seismic modeling.

FIG. 6F illustrates test data associated with executing an exemplary seismic modeling without incorporating ABC-type techniques.

FIGS. 7A-7F illustrate additional simulation data associated with suppressing noise including reflections during execution of examples of the disclosed seismic modeling.

FIGS. 8A-8F illustrate additional simulation data associated with executing the disclosed seismic modeling.

FIGS. 9A-9E, 10A-10E, 11A-11F, and 12A-12F illustrate yet more simulation data associated with executing examples of the disclosed seismic modeling.

FIG. 13 illustrates a flowchart for minimizing noise during execution of examples of the disclosed seismic modeling.

FIG. 14 illustrates an exemplary flowchart for minimizing noise during execution of examples of the disclosed seismic modeling using a plurality of wavefields.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. For some embodiments, the systems and methods presently disclosed may be applicable to exploring resources such as oil, natural gas, water, and Salar brines.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

### High-Level Flowchart

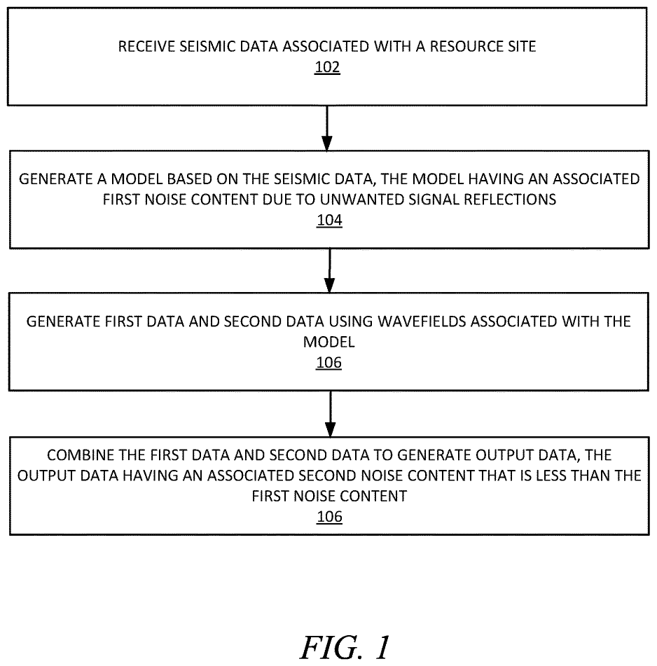

FIG. 1 illustrates an exemplary high-level flowchart for minimizing noise during seismic modeling according to some embodiments of this disclosure. At block 102, a computer processor may be used to receive seismic data associated with a resource site. The computer processor may generate, at block 104, a model based on the seismic data. In one embodiment, the model has a first noise content associated with the seismic modeling. The noise content may be due to unwanted signal reflections during the seismic modeling. At block 106, the computer processor may generate first data and/or second data using the wavefields associated with the model. The computer processor may combine the first data and the second data to generate output data. The output data, according to one embodiment has an associated noise content than is less than the first noise content. As used herein, a wavefield can be wave activity within an area or an extended area, or a space or an extended space and includes characterizations of the wave such as wave amplitude and/or wave frequency within the area or extended area or space or extended space as the case may be.

### Resource Site

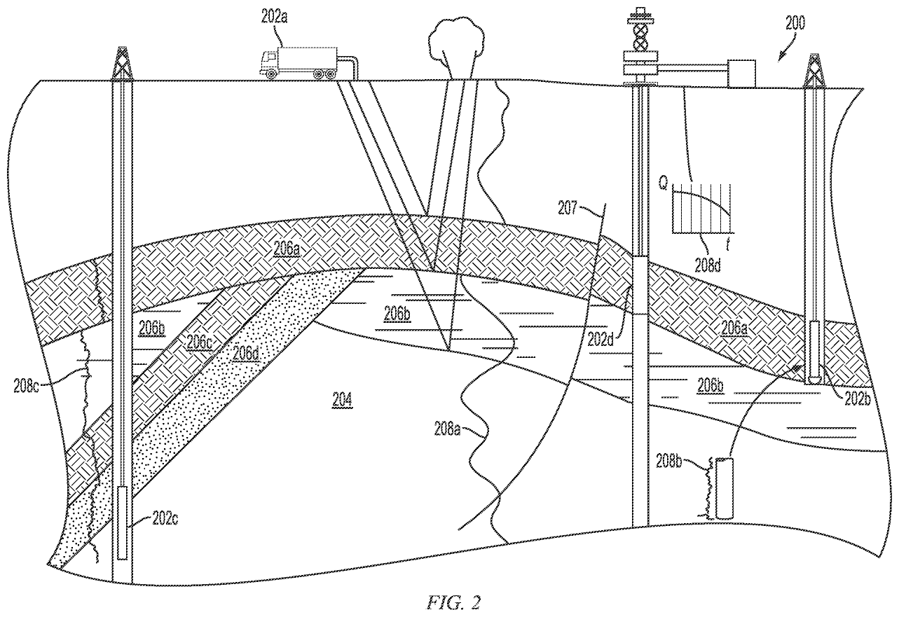

FIG. 2 illustrates a cross-sectional view of an exemplary resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, etc. According to one embodiment, various measurement tools capable of sensing one or more parameters such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As illustrated, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the oil field 200 may contain a variety of geological structures and/or formations, sometimes having extreme complexity. In some locations of a given geological structure, for example below a water line relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc.

Data acquisition tool 202a is illustrated as a measurement truck, which may include devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the oil field 200 to collect data relating to various oil field operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the formation, wellbore, formation fluid/gas, wellbore fluid, gas/oil/water included in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high resolution result set used to, for example, generate a resource model. In other embodiments, test data or synthetic data may also be used in developing the resource model via one or more simulations such as those discussed in association with the flowcharts presented herein.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as Dielectric Scanner® (mark of Schlumberger); acoustic tools including sonic sensors, such as Sonic Scanner® (mark of Schlumberger) or ultrasonic sensors, such as pulse-echo sensor as in UBIM or PowerEcho® (marks of Schlumberger) or flexural sensors PowerFlex® (mark of Schlumberger); nuclear sensors such as Litho Scanner® (mark of Schlumberger) or nuclear magnetic resonance sensors; fluid sampling tools including fluid analysis sensors such as InSitu Fluid Analyzer® (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

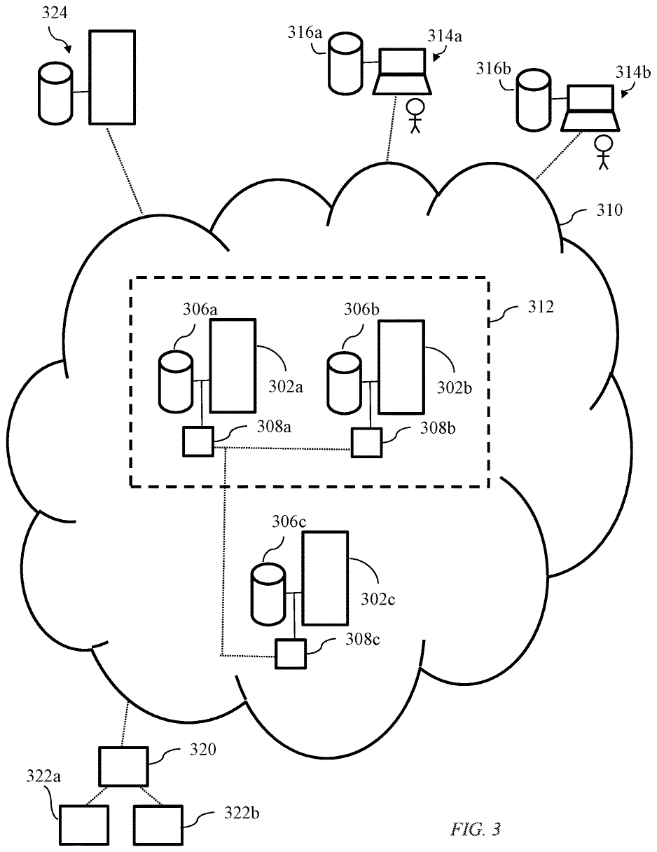

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the oil field 200. In one embodiment, the data is stored in separate databases, or combined into a single database.

### High-Level Networked System

FIG. 3 illustrates a high-level networked system diagram illustrating a communicative coupling of devices or systems associated with the resource site 200. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the oil field 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more oil fields 200 having, for example, a set of terminals 320, each including at least a processor, a memory, and a communication device for communicating with other devices communicatively coupled to the cloud-computing platform 310. The resource site 200 may also have one or more sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the one or more sensors/sensor interfaces 322a and 322b may be processed to generate a one or more resource models or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing and/or application specific integrated circuits.

Further, the steps in the flowcharts described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 1 as well as the flowcharts below may be executed using a signal processing engine stored in memory 306a, 306b, or 306c such that the signal processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs include instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

The proposed method uses an acoustic two-way wave equation modeling method which, in some examples, is formulated in terms of velocity and reflectivity rather than velocity and density. This equation is expressed as:

$$\frac{{\partial }^{2} P}{\partial {t}^{2}} - \{ {V}^{2} {∇}^{2} P + V ∇ V \cdot ∇ P - 2 {V}^{2} ( R \cdot ∇ P ) \} = S , \qquad ( 1 )$$

where P is pressure, V is velocity, S is the source, and R is a vector reflectivity (or simply reflectivity). It is the first Laplacian term inside the curly brackets that controls the propagation speed (kinematics) and the second two terms, include gradients, that control the amplitudes. Equivalently this relationship can be written as:

$$\frac{{\partial }^{2} P}{\partial {t}^{2}} - \{ V ∇ \cdot ( V ∇ P ) - 2 {V}^{2} ( R \cdot ∇ P ) \} = S . \qquad ( 2 )$$

If the vector reflectivity is defined as the normalized rate of acoustic impedance change in each vector direction:

$$R = \frac{1}{2} \frac{∇ ( ρ V )}{ρ V} , \qquad ( 3 )$$

substitution into equation (2) results in an acoustic modeling relationship given by:

$$\frac{{\partial }^{2} P}{\partial {t}^{2}} - {V}^{2} ρ ∇ \cdot ( \frac{1}{ρ} ∇ P ) = S . \qquad ( 4 )$$

If acoustic impedance is constant spatially, the reflectivity is zero and equation (2) degenerates to the non-reflecting wave equation. Partially non-reflecting would be more accurate as it only suppresses normal incidence reflections and as the reflection angle increases from zero it becomes less effective. It is for this reason that its use in RTM is limited to poststack migration.

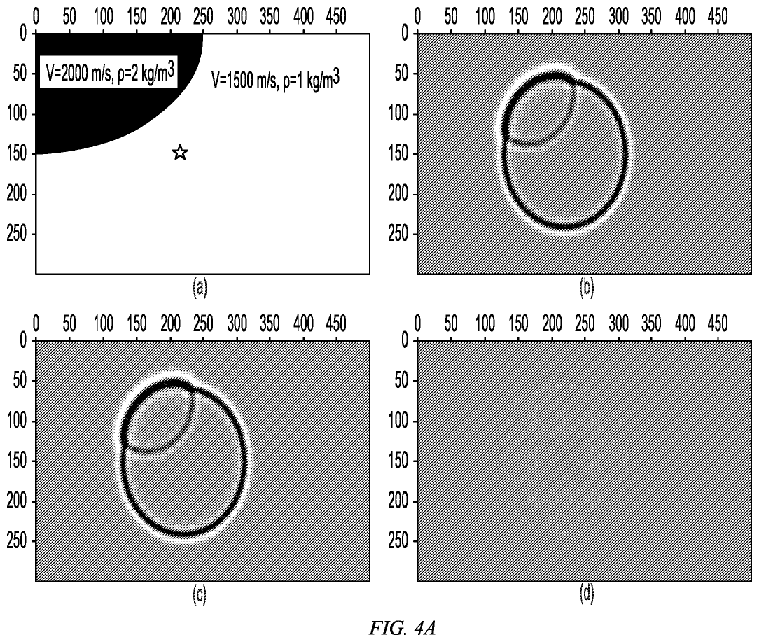

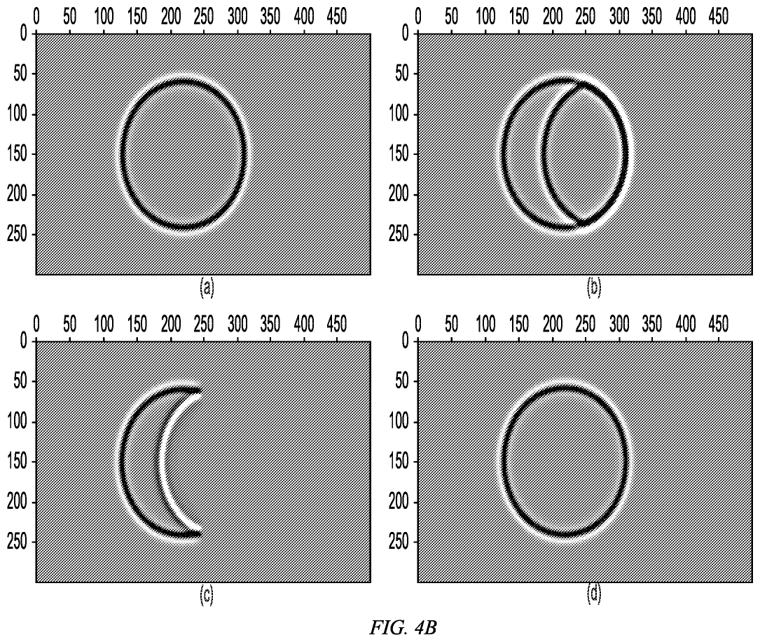

This disclosure, according to some embodiments, implements a multi-dimensional model (e.g., a 2-dimensional model or a 3-dimensional model) that is based on a second order in time and space finite-difference scheme where P, V, and ρ are defined at the same node locations. It is appreciated that buoyancy (1/ρ) and slowness (1/V) averaging may be employed consistently for modeling equations (2) or (4) and thereby minimize interpolation error when model parameters are used at staggered locations. As a demonstration of the accuracy of the instant implementations, modeling may be performed based on equation (2) and equation (4) and using the model in FIG. 4A(a). As shown in the figure, a Ricker wavelet with a peak frequency of 80 Hertz (Hz) may be used as the source function. The 500 meter (m)×300 m model may be sampled on a 1 m×1 m grid. FIG. 4A(b) and (c) display the same wavefield from modeling using equations (4) and (2) respectively. The difference, FIG. 4A(d), between the two tests is around a precision level of floating-point calculations. In particular, FIGS. 4A(a)-(d) illustrate modeling using equations (2) and (4): FIG. 4A(a) shows a model with a contrast in velocity, density and acoustic impedance, the star indicates the location at which a Ricker wavelet with a peak frequency of 80 Hz is injected; FIG. 4A(b) shows a pressure wavefield snapshot from velocity-density modeling using equation (4); FIG. 4A(c) depicts a pressure wavefield snapshot from velocity-reflectivity modeling using equation (2); FIG. 4A(d) shows the difference between the two wavefields multiplied by 10⁵. All wavefields are displayed with the same colour scale.

The basic idea of the disclosed technology is to combine (e.g., average) two or more independent tests including simulations using vector reflectivity modeling (e.g., vector reflectivity using equation (2)). This is illustrated using a homogeneous 500 m×300 m model, sampled on a 1 m×1 m grid. The velocity in this example is 1500 m/s such that a Ricker wavelet with a peak frequency of 80 Hz at location (220 m, 150 m) may be injected into the model. FIG. 4B(a) illustrates the result of acoustic modeling using equation (4). As expected, a circular transmitted wavefront and no reflections is depicted in the figure. FIG. 4B(b) illustrates an equivalent snapshot from vector reflectivity modeling using equation (2) but constraining the components of vector reflectivity to be, for example +1 along an artificial vertical boundary. As seen in FIG. 4B(b), the kinematics of the transmitted wave remain unchanged, but the amplitudes of the transmitted wavefront increase when passing through the vertical boundary and a reflected wave appears with the same polarity and strength as the transmitted wave that did not experience the vertical boundary. FIG. 4B(c) illustrates an equivalent snapshot that forces the components of vector reflectivity to be −1. As seen in the figure, an annihilation of the transmitted wave as it passes through the boundary and a reflected wave with the same strength as the transmitted wave that did not experience the vertical boundary, but with a polarity reversal. FIG. 4B(d) illustrates the average of the two vector reflectivity modeling experiments giving back a result equivalent to the modeling shown in FIG. 4B(a). To reiterate, FIGS. 4B(a)-(d) illustrate depictions associated with constraining each component of vector reflectivity to be, for example, either +1 or −1 at an imaginary vertical boundary at x=250 m: FIG. 4B(a) illustrates a pressure wavefield snapshot from modeling using equation (4); FIG. 4B(b) illustrates a pressure wavefield snapshot from vector-reflectivity modeling that constrains components of vector reflectivity to be +1 at a given boundary; FIG. 4B(c) illustrates a pressure wavefield snapshot from vector-reflectivity modeling that constrains components of vector reflectivity to be −1 at the boundary; and FIG. 4B(d) illustrates an average of the two independent vector reflectivity modeling tests. All wavefields are displayed with the same color scale.

Plane wave pressure reflection, R, and transmission, T, coefficients at normal incidence obey the following relationship:

$$R = \frac{{ρ}_{2} {V}_{2} - {ρ}_{1} {V}_{1}}{{ρ}_{2} {V}_{2} + {ρ}_{1} {V}_{1}} = \frac{2 {ρ}_{2} {V}_{2}}{{ρ}_{2} {V}_{2} + {ρ}_{1} {V}_{1}} - 1 = T - 1 \qquad ( 5 )$$

For R=+1, T=2, and for R=−1, T=0. Averaging would give R=0 and T=1. What is observed in these homogeneous tests are consistent with equation (5).

A persistent problem in the numerical solution of wave equations is the artificial reflections from boundaries introduced by a truncated computational domain. It was previously proposed to expand the model so that no energy reaches the boundary. The zone containing propagating waves can be identified, for instance, by using the Eikonal equation. This scheme greatly increases computing costs. Instead, a variety of so-called absorbing boundary conditions (ABCs) have been proposed to truncate a model while emulating it as being infinite. With any ABC, costs can be traded against quality.

Ignoring any extra operations that need to be performed at a grid node in the ABC and just considering the increase in the number of grid nodes required to implement the ABC illustrates an underestimate of the increase in cost of applying an ABC outside a computational domain of interest. For example, consider a 3D domain with nx×ny×nz grid cells. The (underestimated) cost ratio of a simulation with an ABC of nb cells on each side of the domain to a simulation without an ABC may be given by:

$$Cost Ratio = \frac{( nx + 2 \times nb ) \times ( ny + 2 \times nb ) \times ( nz + 2 \times nb )}{nx \times ny \times nz} \qquad ( 6 )$$

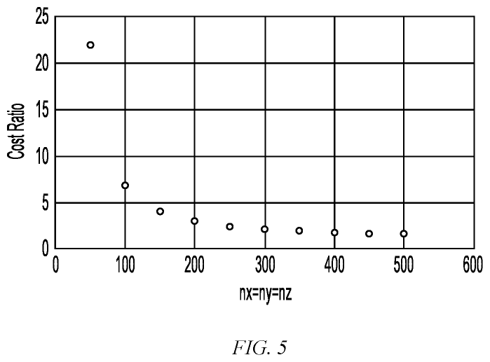

FIG. 5 plots this cost ratio for different sized computational domains with nx=ny=nz for nb=45 (a reasonable size/quality when using the sponge ABC for RTM). For a small domain of 100×100×100 the cost of applying this ABC is almost seven times more expensive than the tests provided in this disclosure that do not rely on an ABC approach. This is a non-trivial benefit of the instant technology in terms of processing costs.

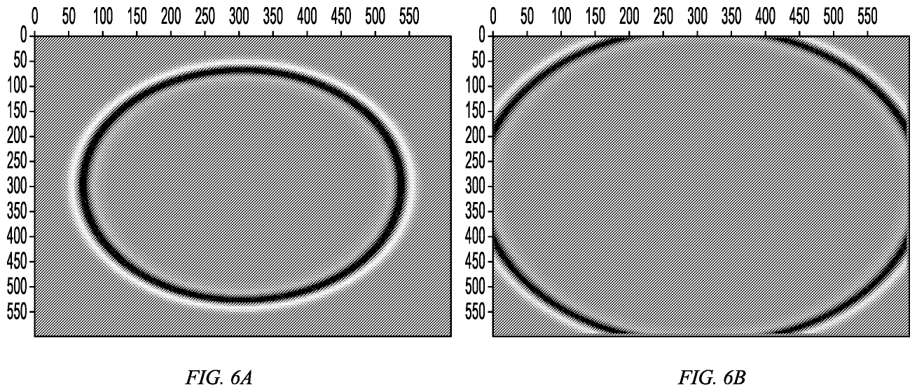

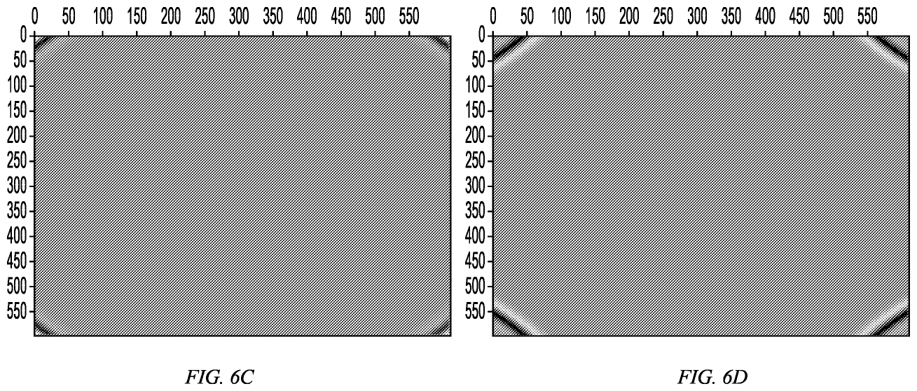

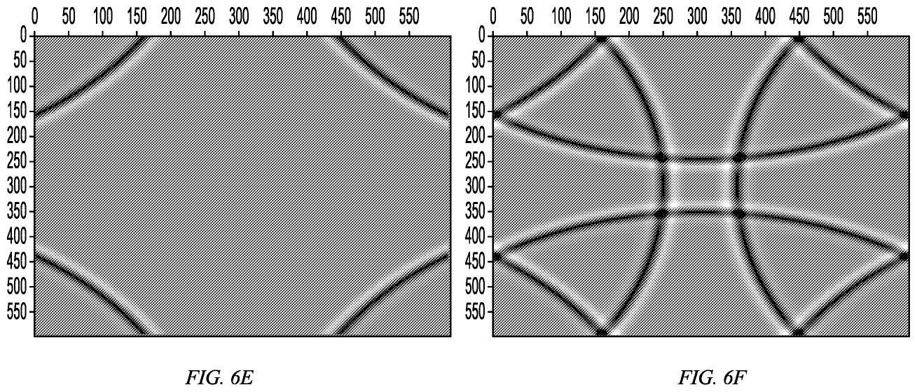

Additional demonstrations are now disclosed for suppressing reflections from the edge of a computational domain. For example, the boundary where the vector reflectivity components is set to be +1 or −1 may be positioned just half of a spatial finite-difference stencil width from the edge of the computational domain. As with the experiments/simulations shown in FIG. 4B, the position of the boundary does not necessarily bear any relationship to the gradients/interfaces that may be present in the velocity (or density) model. The tests may start with a homogeneous 500 m×300 m model, injecting a Ricker wavelet with peak frequency of 80 Hz in the center of the model. Running the two independent tests and averaging the results gives a time progression of wavefield snapshots shown in FIGS. 6A-6E. In particular, FIGS. 6A-6E illustrate tests for suppressing energy that has reflected, for example, an odd number of times from the edge of the computation domain: FIG. 6A-6E illustrate pressure wavefield snapshots as time increases. FIG. 6F illustrates an equivalent pressure wavefield to that in FIG. 6E but from modeling without any ABC. Note that energy that has reflected once may be suppressed, whereas the energy that has reflected twice remains untouched. Clearly, the energy which has reflected once from the boundary of the computational domain has been removed, but those events which reflected twice (in the corners) remain. This is expected in some embodiments as the suppression of reflections with the averaging of the two simulations may rely upon reflections having opposite polarity in the two tests. Energy which has reflected twice would have seen two positive values (which makes a positive) in one test and two negative values (which also makes a positive) in the other. In fact, two tests may suppress all energy that has reflected an odd number of times from the boundary.

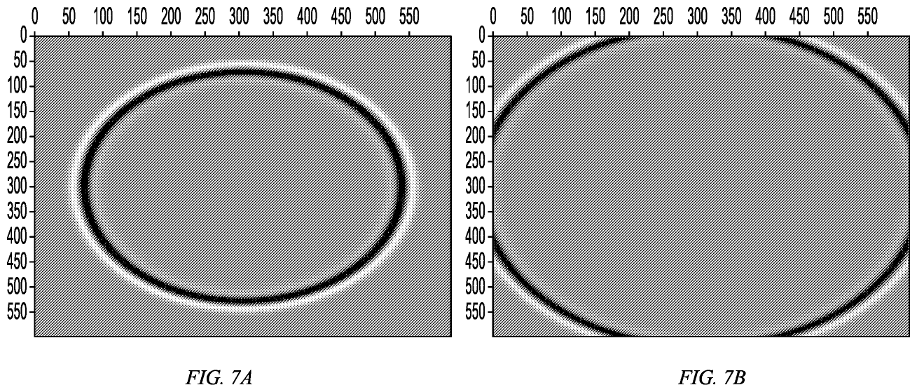

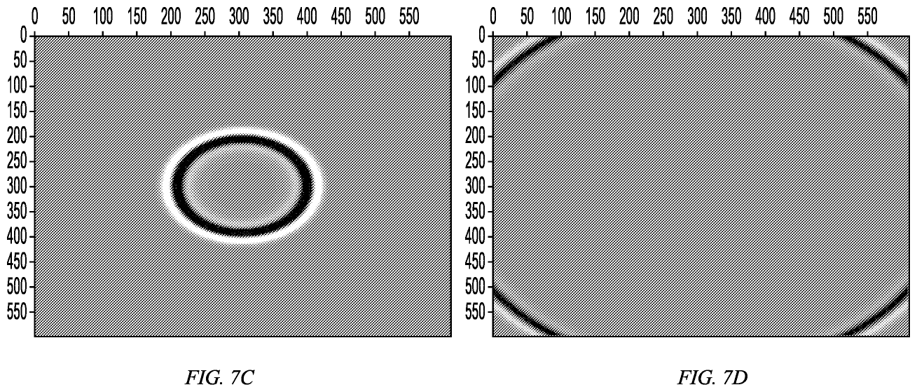

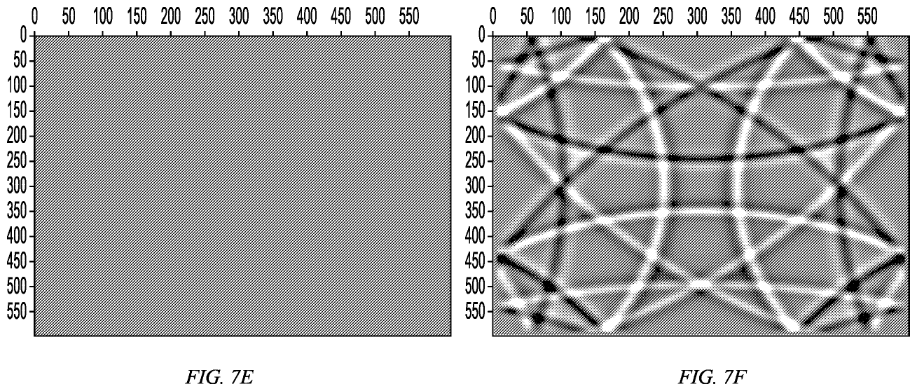

However, with combining (e.g., averaging) of more tests and careful encoding of pieces of the boundary with ±α, where +1≤+α<0<−α≤−1 components of vector reflectivity, different types of unwanted reflections can be suppressed. Results showing averaging eight tests using the disclosed techniques are illustrated in FIGS. 7A-7E. As can be seen in these figures, eight tests for suppressing more types of even order reflections from the edge of the computational domain are disclosed: FIGS. 7A-7E illustrate pressure wavefield snapshots as time increases (a second identical Ricker wavelet is injected once the first has left the simulation); FIG. 7F illustrates an equivalent pressure wavefield to that in FIG. 7E but from one of the eight tests that were averaged. In this case the tests may be run for a much longer time with a second identical Ricker wavelet injected in the central location once the first Ricker wavelet has disappeared. In particular, FIGS. 7A-7E illustrate the progression of the pressure wavefield over time. FIG. 7F illustrates an equivalent wavefield from one of the eight simulations that were averaged.

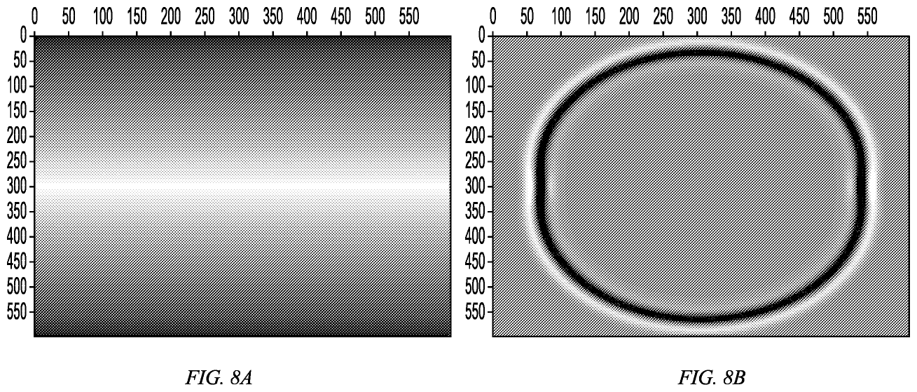

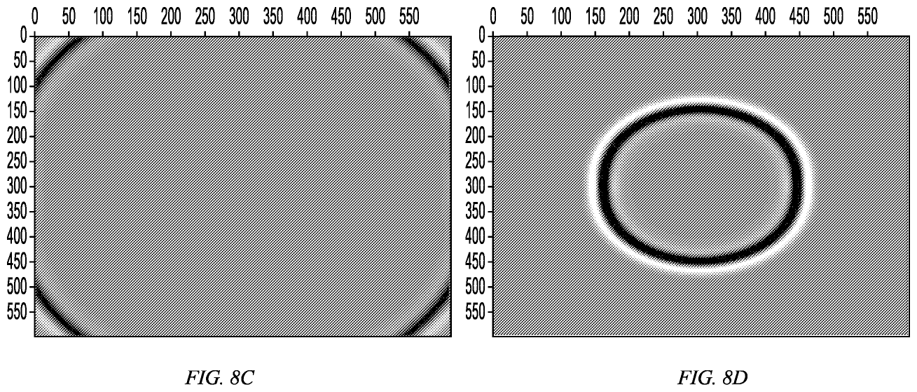

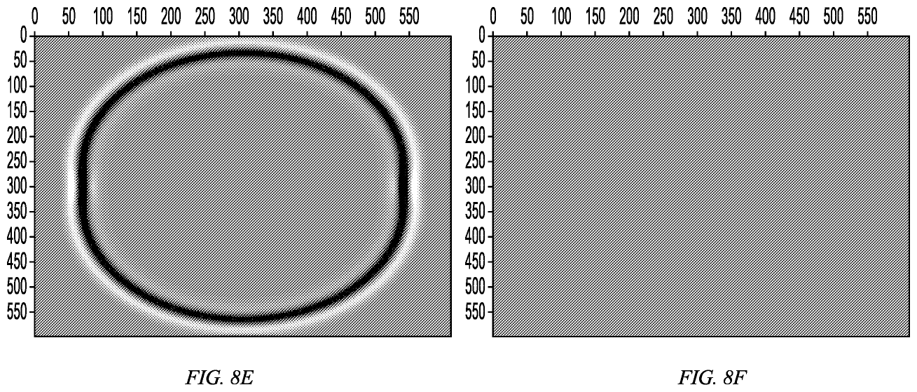

Results are now shown from a variable (but smooth) velocity test. A velocity model is illustrated in FIG. 8A. This example further illustrates vertical variations and is symmetric about a center portion of the model where the same sequence of Ricker wavelets as in the previous tests was injected. FIGS. 8B-8F illustrate the progression of the pressure wavefield over time.

Additional discussions related to reflections from high velocity contrasts are now disclosed. Reverse-time migration (RTM) and least-squares reverse-time migration (LSRTM) may be derived under a single scattering assumption, implicating the use of smooth background migration velocity models. However, to obtain the best kinematic image, high-contrast velocity discontinuities may be built into the migration velocity model. For example, salt bodies may be typically interpreted at high resolution and included without smoothing to enable a better subsalt RTM image. Low-frequency artifacts arising from including such high-contrast discontinuities in a migration velocity model may be handled with a Laplacian filtering workflow. However, other crosstalk image artifacts that could be interpreted as false structure (not low-frequency) can be generated from imaging conditions applied to the source and receiver wavefields. It would be good to have control over suppressing reflections during propagation whilst retaining other benefits of using two-way modeling. Other current techniques proposed include applying a directional damping term to the wave equation in areas of the velocity model where unwanted reflections occur. One limitation of this approach is that the direction needs to be specified and hence suppression of reflections illuminated from “above” and “below” cannot be achieved simultaneously.

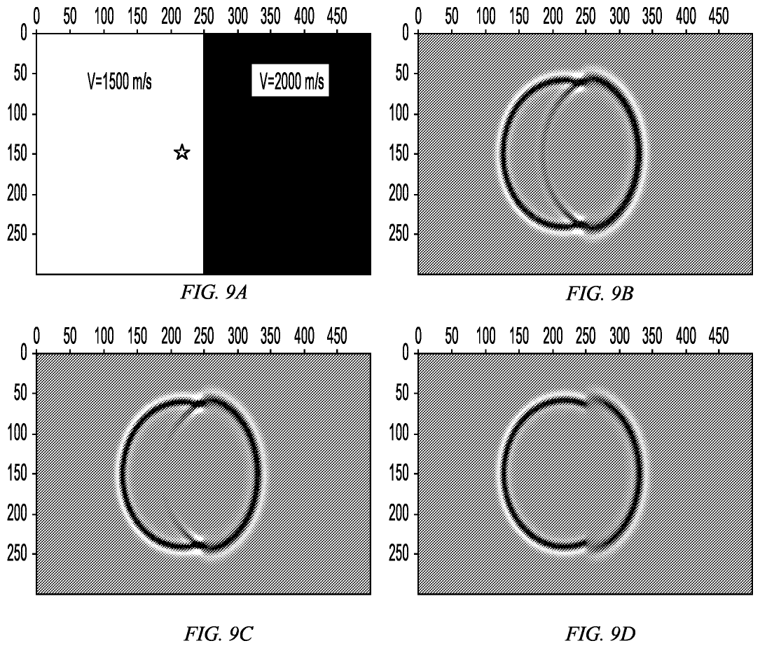

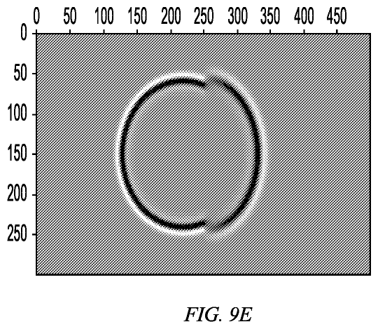

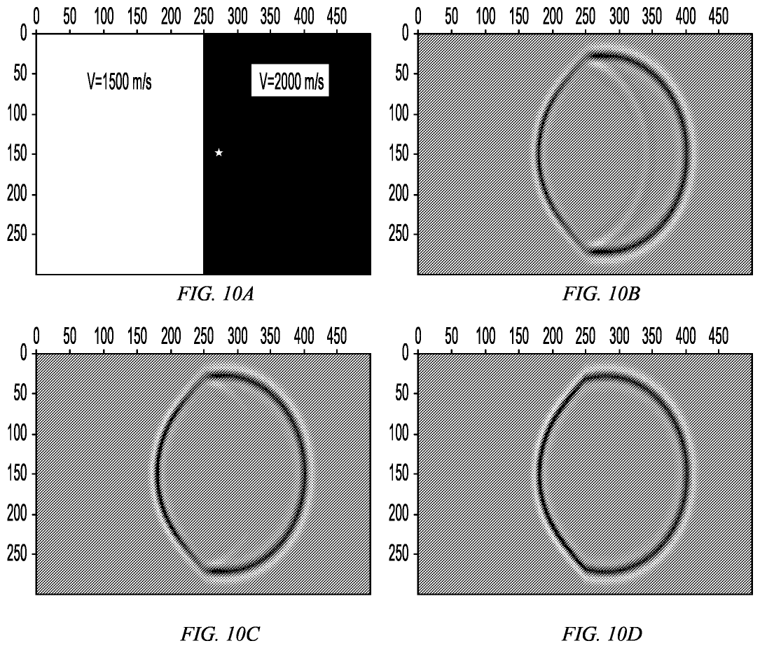

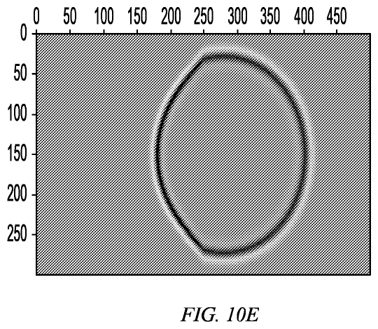

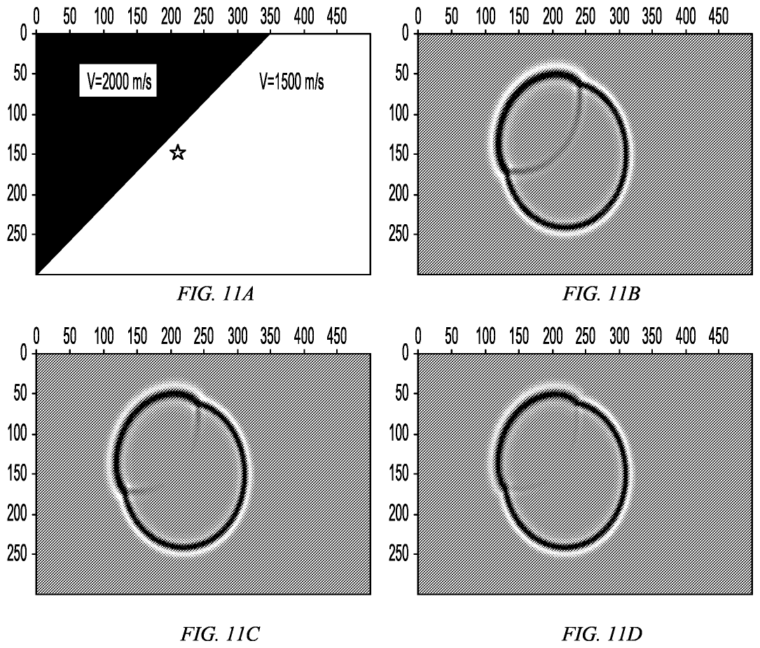

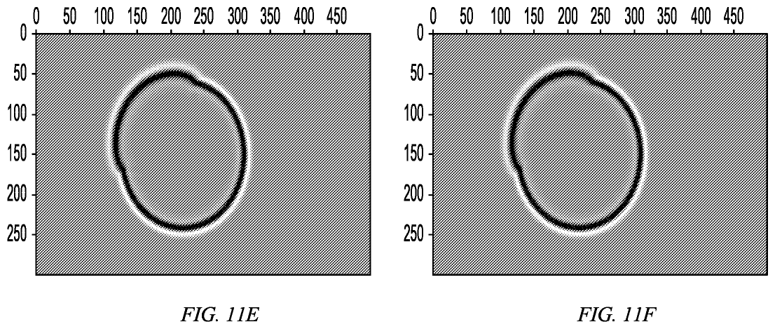

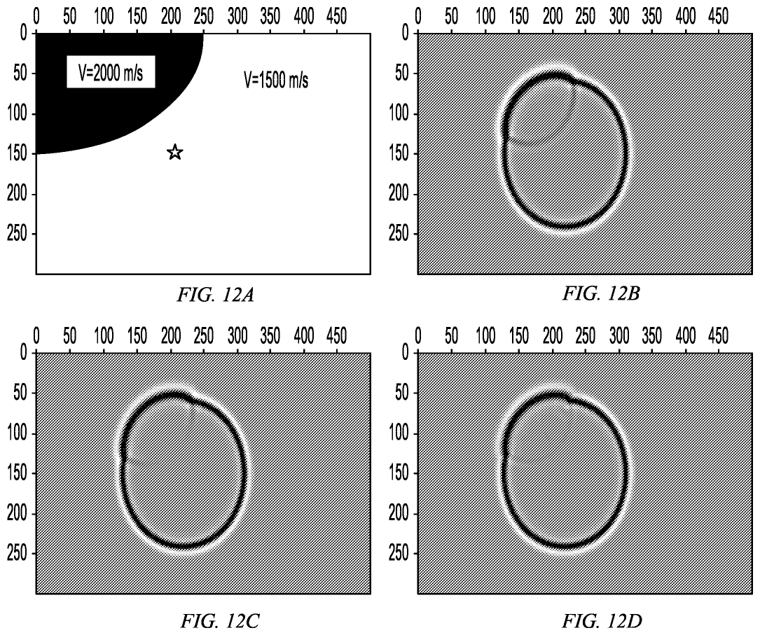

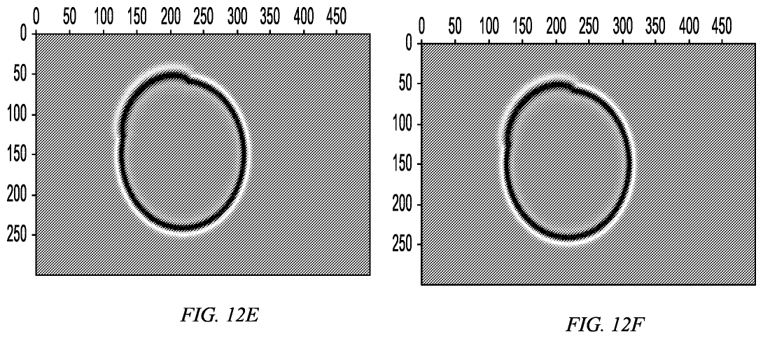

Additional embodiments demonstrating the technology are now described for suppressing reflections from a contrast in the velocity model. In particular, results show that the described techniques work for energy reflected from either side of a selected boundary. Initiated tests with a 500 m×300 m simple half-space velocity models are illustrated in FIGS. 9A and 10A. The tests in FIGS. 9A and 10A may be generated from inserting a Ricker wavelet, with a peak frequency of 80 Hz, 30 m to the left and right of the vertical interface. FIGS. 9B and 10B illustrate the result of exemplary modeling; FIGS. 9C and 10C illustrate the result of modeling using a current non-reflecting wave equation; FIGS. 9D and 10D illustrate the result from our proposed method of averaging two simulations. All these tests were carried out with a 1 m cell size and the same propagation time step set appropriately. It is clear to see the limitation of the current non-reflecting wave equation. The suppression of the reflection gets worse as the angle of incidence increases away from normal-incidence. The proposed method does not have this limitation, but there is some residual reflection visible at all angles. This is caused by the property averaging that is performed at staggered node locations (reflectivity is defined at staggered node locations). FIGS. 9E and 10E illustrate the results of the described approach using a cell size twice as fine. Clearly the suppression improves as the error from property averaging is diminished. The error from property averaging will be worst for a 45 degree interface using a square grid cell. This case is demonstrated in FIGS. 11A-11F using a similar test but tilting the interface. Further, the interface position is modified to incorporate a range of dips. The results are illustrated in FIGS. 12A-12F. The interface is concave with respect to the source position in this experiment and only a first order reflection is generated. A convex interface may have the potential to generate multiple reflections and averaging two modeling experiments would suppress the odd order reflections.

Rather than using the velocity-reflectivity propagator, one might believe the same could be achieved in these experiments from using a velocity-density propagator and modifying the density to achieve a reflectivity of ±1. However, this is not the case, which can be understood by looking at equation (5). The way for reflectivity to tend towards unity is to have the density on one side of the interface tend towards infinity. Finite-difference stability conditions for sensible ranges of density are typically set based only on the maximum velocity (as well as the maximum frequency and the cell size) and ignore the size of density contrasts in the model. Rigorously, the size of density contrasts should also be used in a stability condition to set the propagation time step. In doing so, the time step will tend to zero as the density contrast tends to infinity. With the velocity-reflectivity propagator (and so long as the reflectivity is bounded by ±α, where +1≤+α<0<−a≤−1); the propagation time step can be set in using the maximum velocity.

It is appreciated that the described approach works equally well when there is non-zero reflectivity caused by variations in density away from the boundary at which reflectivity components are forced to be ±α, where +1≤+α<0<−α≤−1). Preferably, α=±1. Furthermore, each of the individual modeling tests that are combined or averaged may preserve energy. However, by nature of reflection suppression, the averaged simulations do not. The implemented approach uses low order finite-difference operators. However, the described approach is equally applicable to high-order finite-differencing as well as alternative implementations. As independent modeling tests are conducted, these tests may be run in parallel or in series saving all the relevant samples and averaging results sets at the end of the tests. It is assumed that each of the independent simulations employed similar discretization (model and propagation time step) approaches.

### Additional Flowcharts

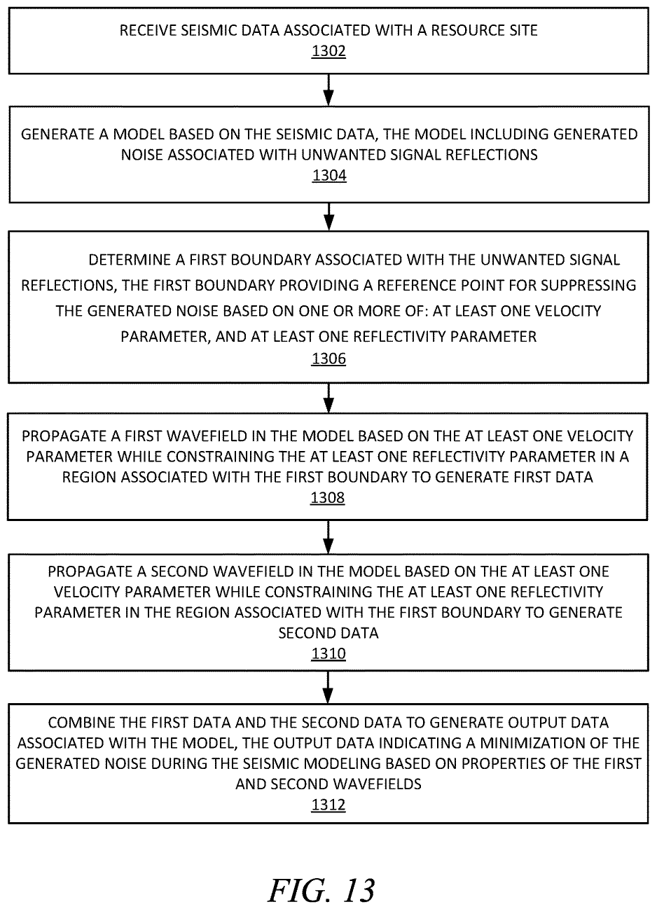

FIG. 13 illustrate a flowchart for minimizing noise during seismic modeling. At block 1302, a computer processor, for some examples, is used to receive seismic data associated with a resource site. The computer processor is configured to generate, at block 1304, a model based on the seismic data. In one embodiment, the model has an associated generated noise due to unwanted signal reflections during the seismic modeling. For example, the generated noise may include a first noise content associated with the model during the seismic modeling. At block 1306, the computer processor may determine a first boundary or a second boundary or a third boundary, etc. associated with the unwanted signal reflections. The first boundary, or the secondary, or the third boundary, etc., may provide or otherwise serve as a reference point for suppressing the generated noise based on one or more of at least one velocity parameter and/or at least one reflectivity parameter. The computer processor is configured to, at block 1306, be used to propagate a first wavefield in the model based on the at least one velocity parameter while constraining the at least one reflectivity parameter in a region associated with the first boundary to generate first data. The computer processor is configured to be used, at block 1308, to propagate a second wavefield in the model based on the at least one velocity parameter while constraining the at least one reflectivity parameter in the region associated with the first boundary to generate second data. The computer processor is configured to be used, at block 1312, to combine the first data and the second data to generate output data associated with the model. The output data may indicate a minimization of the generated noise during the seismic modeling based on properties of the first and second wavefields. In particular, the output data may have an associated second noise content that is less than the first noise content discussed in association with block 1304.

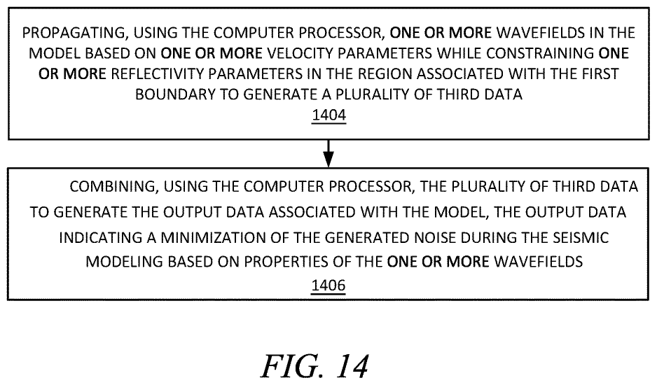

FIG. 14 illustrates an exemplary flowchart for minimizing noise during seismic modeling using a plurality of wavefields. At block 1404, the computer processor is configured to be used to propagate one or more wavefields in the model based on one or more velocity parameters while constraining one or more reflectivity parameters in the region associated with the first boundary, or the second boundary, or the third boundary, etc., to generate a plurality of third data. The computer processor is configured to be used to combine the plurality of third data to generate the output data associated with the model. In one embodiment, the output data indicates a minimization of the generated noise during the seismic modeling based on properties of the one or more wavefields.

These and other implementations may each optionally include one or more of the following features. The at least one velocity parameter is a spatially varying parameter that numerically characterizes velocity data associated with the model. The at least one reflectivity parameter is a spatially varying parameter associated with the region associated with the first boundary or the second boundary, or the third boundary, etc. In one embodiment, the seismic data includes one or more of: data captured by one or more sensors at the resource site, or synthetic data including test data. In addition, the model includes one of: an acoustic model including the at least one velocity parameter and the at least one reflectivity parameter, or a pseudo-acoustic model including an anisotropic velocity parameter and a Thomsen parameter. Furthermore, the first data may include a first value and the second data may include a second value such that the first value and the second value are numerical opposites of each other. For example, the first value may be +1 and the second value may be −1. In some instances, the first value is a real number between 0 and +1, and the second value is a real number between 0 and −1. Moreover, the first boundary or the second boundary or the third boundary, etc., may represent an edge of a computational domain associated with the model. Additionally, the first boundary or the second boundary, or the third boundary, etc., may correlate with a discontinuity in the region associated with the first boundary, or the second boundary, or the third boundary, etc., respectively, based on the at least one velocity parameter.

In one embodiment, the computer processor may initiate generation of a first visualization on a graphical interface device, such that the first visualization indicates the output data associated with the model. Furthermore, combining the first data and the second data may include executing an averaging operation using the first data and the second data to generate the output data. It is appreciated that the unwanted signal reflections may include reflections associated with a boundary of a computational domain imposed on the model. It is further appreciated that the unwanted signal reflections may include reflections associated with a velocity contrast in the region associated with the first boundary or the second boundary, or the third boundary, etc., respectively, such that the velocity contrast causes unwanted imaging artifacts in a reverse-time migration of the unwanted signal reflections.

The systems and methods described in this disclosure enable improvements in autonomous operations at resource sites such as oil and gas fields. The systems and methods described allow an ordered combination of new results in autonomous operations including wireline and testing operations with existing results. The systems and methods described cannot be performed manually in any useful sense. Simplified systems may be used for illustrative purposes but it will be appreciated that the disclosure extends to complex systems with many constraints thereby necessitating new hardware-based processing system described herein. The principles described may be combined with a computing system to enable an integrated and practical application to achieve autonomous operations in oil and gas fields.

These systems, methods, processing procedures, techniques, and workflows increase effectiveness and efficiency. Such systems, methods, processing procedures, techniques, and workflows may complement or replace conventional methods for identifying, isolating, transforming, and/or processing various aspects of data that is collected from a subsurface region or other multi-dimensional space to enhance flow simulation prediction accuracy.

A benefit of the present disclosure is that more effective methods for downhole operations may be employed. It is appreciated that the application and benefit of the disclosed techniques are not limited to subterranean wells and reservoirs and may also be applied to other types of energy explorations and/or other resource explorations (e.g., aquifers, Lithium/Salar brines, etc.).

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for minimizing noise during seismic modeling, the method comprising:
receiving, using a computer processor, seismic data associated with a resource site;
generating, using the computer processor, a model based on the seismic data, the model having generated noise associated with unwanted signal reflections during the seismic modeling;
determining, using the computer processor, a first boundary associated with the unwanted signal reflections, the first boundary providing a reference point for suppressing the generated noise based on one or more of:
at least one velocity parameter, and
at least one reflectivity parameter;
propagating, using the computer processor, a first wavefield in the model based on the at least one velocity parameter while constraining the at least one reflectivity parameter in a region associated with the first boundary to generate first data;
propagating, using the computer processor, a second wavefield in the model based on the at least one velocity parameter while constraining the at least one reflectivity parameter in the region associated with the first boundary to generate second data; and
combining, using the computer processor, the first data and the second data to generate output data associated with the model, the output data indicating a minimization of the generated noise during the seismic modeling based on properties of the first and second wavefields.

2. The method of claim 1, wherein the at least one velocity parameter is a spatially varying parameter that numerically characterizes velocity data associated with the model.

3. The method of claim 1, wherein the at least one reflectivity parameter is a spatially varying parameter associated with the region associated with the first boundary.

4. The method of claim 1, wherein the seismic data includes one or more of:
data captured by one or more sensors at the resource site, or
synthetic data including test data.

5. The method of claim 1, wherein the model is one of:
an acoustic model including the at least one velocity parameter and the at least one reflectivity parameter, or
a pseudo-acoustic model including an anisotropic velocity parameter and a Thomsen parameter.

6. The method of claim 1, wherein:
the first data includes a first value and the second data includes a second value, and
the first value and the second value are numerical opposites of each other.

7. The method of claim 6, wherein the first value is +1 and the second value is −1.

8. The method of claim 6, wherein the first value is a real number between 0 and +1, and the second value is a real number between 0 and −1.

9. The method of claim 1, wherein the first boundary represents an edge of a computational domain associated with the model.

10. The method of claim 1, wherein the first boundary correlates with a discontinuity in the region associated with the first boundary based on the at least one velocity parameter.

11. The method of claim 1, comprising initiating, using the computer processor, generation of a first visualization on a graphical interface device, the first visualization indicating the output data associated with the model.

12. The method of claim 1, wherein combining the first data and the second data includes executing an averaging operation using the first data and the second data to generate the output data.

13. The method of claim 1, comprising
propagating, using the computer processor, one or more wavefields in the model based on one or more velocity parameters while constraining one or more reflectivity parameters in the region associated with the first boundary to generate a plurality of third data, and
combining, using the computer processor, the plurality of third data to generate the output data associated with the model, the output data indicating a minimization of the generated noise during the seismic modeling based on properties of one or more wavefields.

14. The method of claim 1, wherein the unwanted signal reflections include reflections associated with a boundary of a computational domain imposed on the model.

15. The method of claim 1, wherein the unwanted signal reflections include reflections associated with a velocity contrast in the region associated with the first boundary such that the velocity contrast causes unwanted imaging artifacts in a reverse-time migration of the unwanted signal reflections.

16. A computer program for minimizing noise during seismic modeling, the computer program comprising instructions, that when executed by a computer processor of a computing device, causes the computing device to:
receive seismic data associated with a resource site;
generate a model based on the seismic data, the model having generated noise associated with unwanted signal reflections during the seismic modeling;
determine a first boundary associated with the unwanted signal reflections, the first boundary providing a reference point for suppressing the generated noise based on one or more of:
at least one velocity parameter, and
at least one reflectivity parameter;
propagate a first wavefield in the model based on the at least one velocity parameter while constraining the at least one reflectivity parameter in a region associated with the first boundary to generate first data;
propagate a second wavefield in the model based on the at least one velocity parameter while constraining the at least one reflectivity parameter in the region associated with the first boundary to generate second data; and
combine the first data and the second data to generate output data associated with the model, the output data indicating a minimization of the generated noise during the seismic modeling based on properties of the first and second wavefields.

17. The computer program of claim 16, wherein the seismic data includes one or more of:
data captured by one or more sensors at the resource site, or
synthetic data including test data.

18. A system for minimizing noise during seismic modeling, the system comprising:
a computer processor, and
memory storing a signal processing engine that includes instructions that are executable by the computer processor to:
receive seismic data associated with a resource site;
generate a model based on the seismic data, the model having generated noise associated with unwanted signal reflections during the seismic modeling;
determine a first boundary associated with the unwanted signal reflections, the first boundary providing a reference point for suppressing the generated noise based on one or more of:
at least one velocity parameter, and
at least one reflectivity parameter;
propagate a first wavefield in the model based on the at least one velocity parameter while constraining the at least one reflectivity parameter in a region associated with the first boundary to generate first data;
propagate a second wavefield in the model based on the at least one velocity parameter while constraining the at least one reflectivity parameter in the region associated with the first boundary to generate second data; and
combine the first data and the second data to generate output data associated with the model, the output data indicating a minimization of the generated noise during the seismic modeling based on properties of the first and second wavefields.

19. The system of claim 18, wherein the unwanted signal reflections include reflections associated with a boundary of a computational domain imposed on the model.

20. The system of claim 18, wherein the seismic data includes one or more of:
data captured by one or more sensors at the resource site, or
synthetic data including test data.
